(19) United States
(12) Patent Application Publication
(10) Pub. No.: US 2010/0170993 A1
(43) Pub. Date: Jul. 8, 2010

(54) Aerodynamic Fairing for aircraft lift strut

(76) Inventor: Kent Paul Misegades, Cary, NC (US)

Correspondence Address: Kent Misegades, 204 Parkmeadow Dr., Cary, NC, 27519, US

(21) Appl. No.: 12/319,207

(22) Filed: Jan. 5, 2009

(51) Int. Cl. B64C 7/00

(52) U.S. Cl. 244/130

(57) ABSTRACT

An aerodynamic fairing for the lift strut of an aircraft is disclosed. The fairing has an airfoil shape on the outside specially chosen to minimize aerodynamic drag. It has a thin external skin and an internal structure of foam material to provide stiffness and to allow its secure attachment around the existing lift strut. Special fillets are provided at either end of the fairing to assure a smooth transition of the fairing to the adjacent fuselage and wing undersurface to further minimize aerodynamic drag. The fairing is split at its trailing edge, allowing installation and removal by a standard aircraft fastener integrated in the fairing's trailing edge.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates to the reduction of aircraft aerodynamic drag. More particularly, this invention relates to a high-wing aircraft whose aerodynamic lifting loads created by its wing during flight are partially transferred from the wing structure to the lower extremity of the aircraft's fuselage (body) structure by means of a so-called “lift strut”.

A lift strut is a tubular length of an aircraft fabrication material affixed on one of its end to the underside of the aircraft's wings approximately mid-way down the wing's length (or “semi-span”), and on its other end to the lower extremity of an aircraft's fuselage. Lift struts are employed on nearly all single and multi-engine, propeller-driven “high-winged” aircraft with cruise speeds below 200 mph.

The cross-sectional shape of lift struts currently in use represents a blunt teardrop. While the aerodynamic drag resulting from airflow around this shape is marginally better than for the airflow around a circular-shaped strut, it nevertheless represents a significant portion of the aircraft's overall drag, limiting its speed and increasing the power required for flight over comparable aircraft that do not employ lift struts.

The inventor has performed rigorous, state-of-the-art in-flight investigations of the airflow around conventional lift struts to confirm the potential for aerodynamic drag reduction when this invention is employed.

While the elimination of the lift strut might have benefits from an aerodynamic standpoint, the increased weight and complexity needed for the additional internal structure generally does not justify this. The high costs to retrofit and certify existing aircraft to operate without a lift strut are prohibitive, making the continued use of lift struts on existing aircraft necessary.

While the drag caused by conventional blunt lift struts could be reduced through the use of a new lift strut with an improved cross-section yielding lower aerodynamic drag, the manufacturing limitations, added weight and the cost to recertify and retrofit existing aircraft with a new lift strut make this option prohibitive.

An added aspect of aerodynamic drag caused by the strut is the so-called “interference drag” created at both ends of the lift strut where it attaches to the undersurface of the wing and the lower extremity of the fuselage. On many aircraft, a specially-designed fillet is provided to assure a smooth transition from the strut surface to the adjacent wing or fuselage external surfaces. This is especially critical, as over 30% of the total drag caused by such a strut can in fact originate at its two ends. This invention therefore includes fillets specially designed for the lift strut fairing. These fillets are integrated with the fairing and are part of the invention.

This invention therefore provides for an optimal, low-drag shape through a light weight fairing that easily installs around the existing lift strut.

It is essential that the fairing be aligned correctly relative to the direction of airflow and that it be attached securely to the existing lift strut to withstand aerodynamic loads or those experienced during ground handling of the aircraft (lift struts provide a convenient means to push or pull an aircraft when on the ground). This is achieved in the invention through the use of a strong external skin of aircraft fabrication material and an internal structure of rigid foam.

2. Brief Discussion of the Prior Art

All high-winged aircraft (whose structure includes lift struts) known to the inventor make use of a lift strut whose cross-sectional shape exhibits a blunt, teardrop shape producing high aerodynamic drag. The inventor is aware of several ultra-light aircraft that make the use of simple rod-shaped lift struts with a circular cross-section sheathed in a simple fairing of an improved aerodynamic shape. However the inventor is not aware of any prior art fairings applied to non-circular aircraft lift struts, and no patents exist for the reduction of aerodynamic drag of a lift strut by means of a fairing as described in this invention.

### BRIEF SUMMARY OF THE INVENTION

The invention in its simplest form is a fairing mounted around an existing lift strut of a light aircraft comprising: an elongated fairing with a low-drag cross-section, fillets on either end of the fairing, and a fastening device on the fairing's trailing edge.

The structure of the fairing is one wherein the fairing is provided with a relatively thin outer skin formed of aircraft fabrication material, an internal structure made from a rigid foam material, and an aircraft fastener along the entire length of the fairing's trailing edge. The two fillets on either end of the fairing assure a smooth transition of the fairing's external surface to the adjoining lower surface of the aircraft's wing and the aircraft's lower fuselage. These fillets have the same external and internal structure and material as the fairing over the aircraft's lift strut.

When the invention is employed on an existing aircraft, the aerodynamic drag of said aircraft is reduced, resulting in either a greater speed for a given power output of the aircraft's engine, or the ability to operate said aircraft at the same speed but at a lower power output of the aircraft's engine, yielding lower fuel consumption.

### BRIEF DESCRIPTION OF THE SEVERAL VIEWS OF THE DRAWINGS

FIG. 1 is a pictorial view of the fairing of this invention mounted on an aircraft.

FIG. 2 is a cross-sectional view of the fairing of this invention.

FIG. 3 presents two pictorial views of the two fillets provided at either end of the fairing of this invention.

### DETAILED DESCRIPTION OF THE INVENTION

In the drawings the like numbers refer to like objects and the proportions of some parts of the drawings have been modified to facilitate illustration.

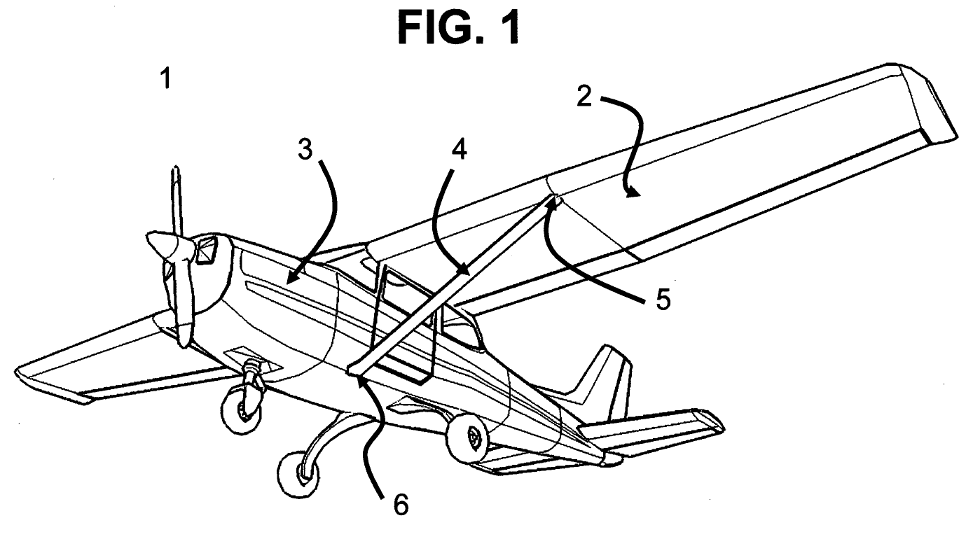

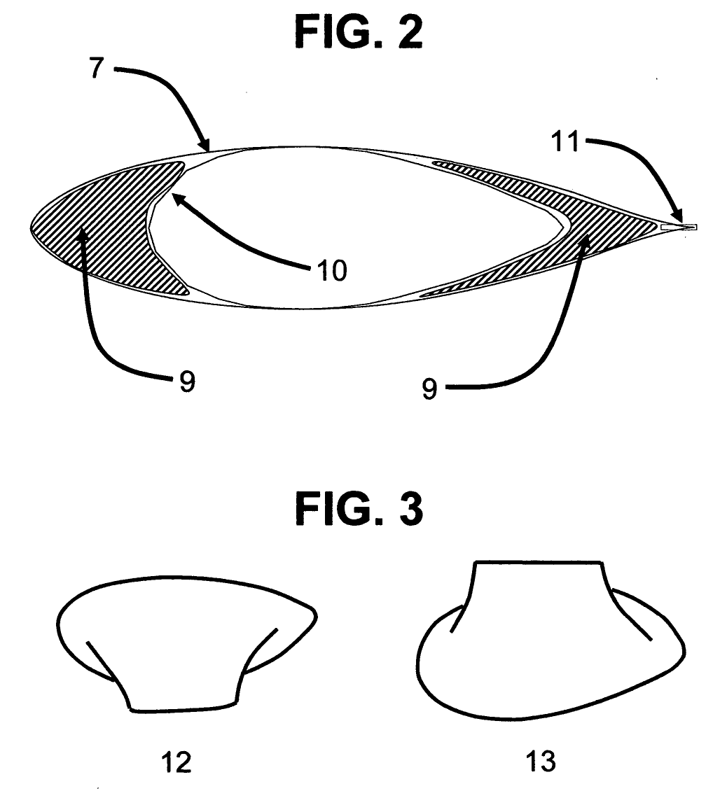

Referring now to FIGS. 1 through 3, in which the fairing of this invention is illustrated. Aircraft 1 has a wing 2, a fuselage 3 and a lift strut 4 that transfers part of the lifting load generated by the wing 2 to the fuselage 3. At either end of the lift strut 4, fillets 5 and 6 assure a smooth transition from the lift strut fairing 4 to the underside of the wing 2 and lower fuselage 3.

The fairing 7 comprises a thin external skin of aircraft fabrication material and sheaths the aircraft lift strut's structure 10. The external shape of fairing 7 has been chosen so as to reduce its overall cross sectional drag. Between the inside wall of the fairing 7 and the outside wall of the lift strut 10 rigid foam 9 is used to provide rigidity to the fairing 7 and assure its secure position relative to the lift strut 10. An aircraft fastener 11 down the length of the fairing 7 provides the means to secure and remove the fairing 7.

At either end of the fairing 7 specially-designed fillets 12 and 13 are provided to assure the smooth transition from the lift strut fairing 4 to the underside of the wing 2 and lower fuselage 3. These fillets are made using aircraft fabrication material and employ aircraft fasteners.

The above disclosures are enabling and would permit one skilled in the art to make and use the fairing of this invention without undue experimentation. The applicant has provided in his specifications and drawings, enabling disclosures of his invention and the best mode of practicing it. It should be understood that there are numerous variants of low-drag fairing shapes that would be made obvious by the above disclosures that would be within the scope of the appended claims. Therefore it should be understood that the scope of this invention should not be limited to the scope of the embodiments disclosed above but that the scope of this invention should only be limited by the scope of the appended claims and all equivalents thereto that would be made obvious thereby.

The embodiments of the invention in which exclusive property or privilege is claimed are defined as follows:

1. An aircraft, comprising: a wing whose inner end is attached to the upper extremity of said aircraft's fuselage; wherein the aerodynamic load on said wing is partially transferred to the lower extremity of the fuselage by means of a lift strut; wherein the lift strut due to its blunt shape creates aerodynamic drag during flight; wherein a fairing encapsulates the entire length of said lift strut so as to minimize said aerodynamic drag.

2. The aircraft of claim 1, wherein the fairing comprising a constant external cross-sectional shape over most of its length, so devised to minimize the aerodynamic drag of said lift strut.

3. The aircraft of claim 1, wherein the fairing comprising fillets at both of its extremities, so devised to provide a smooth transition to the fuselage and wing undersurface and further minimizing the aerodynamic drag of said lift strut.

4. The aircraft of claim 1, wherein the fairing is provided with a thin outer skin formed of an aircraft fabrication material and an internal rigid foam material to assure stiffness of said fairing and to allow its secure attachment to said lift strut.

5. The aircraft of claim 1, wherein the fairing comprising a flexible leading edge and a split trailing edge, allowing installation and removal around said lift strut.

6. The aircraft of claim 1, wherein the fairing is secured by a standard aircraft fastener integrated in the fairing's trailing edge.
